(19) United States
(12) Patent Application Publication
(10) Pub. No.: US 2012/0222744 A1
(43) Pub. Date: Sep. 6, 2012

(54) CAVITATION REACTOR

(75) Inventors: Dominik Maslak, München (DE); Dirk Weuster-Botz, München (DE)

(73) Assignee: Technische Universitat Munchen, Munchen (DE)

(21) Appl. No.: 13/387,858

(22) PCT Filed: Jun. 9, 2010
(86) PCT No.: PCT/EP2010/003469

§ 371 Date: May 9, 2012

(30) Foreign Application Priority Data
Jul. 28, 2009 (DE) 102009034977.4

(51) Int. Cl. B01F 3/04; F17D 1/00

(52) U.S. Cl. 137/1; 261/19

(57) ABSTRACT

Cavitation reactor for hydrodynamic generation of homogeneous, oscillating cavitation bubbles in a fluid, including, while forming a flow duct and arranged one behind the other in the direction of flow of the fluid, an acceleration section designed to increase a flow velocity, a diaphragm arranged transversely to the direction of flow with a plurality of micro-passages designed for generating cavitation bubbles, where at least 10 micro-passages per cm² are provided over an entire flow cross-sectional surface defined on an oncoming flow side of the diaphragm, a stabilization section designed for stabilizing an oscillation of cavitation bubbles, and a collapse section with at least one widening of a flow cross-sectional surface of the flow duct in the direction of flow.

The invention relates to a method and to a cavitation reactor using said method for generating hydrodynamic, homogeneous and oscillating cavitation bubbles. Furthermore, the invention provides a method for disinfecting a fluid and/or for manipulating biological membranes and cells, and a method for emulsifying or suspending or promoting the reaction of at least two substances.

Acoustic cavitation is used nowadays in many different fields for accelerating or just permitting material transformations and reactions in aqueous solutions. The possibility of influencing biological cells is also discussed here. There are already more model representations and scale laws for acoustic cavitation, particularly from medical ultrasound research, than for hydrodynamic cavitation. An important result of this is that an oscillation of micro-bubbles, caused by pressure amplitudes, and newly created cavitation bubbles have an important influence on the cell membrane. It was shown that these oscillating bubble fields can open and close biological membranes briefly and transiently without the cells suffering major or even lethal damage when doing so. Depending on the intensity of cavitation and/or the pressure amplitude and the frequency, some of the cells can however also be permanently damaged and even killed.

Hydrodynamic cavitation is not yet as far developed in this respect. The generation of hydrodynamic cavitation is restricted here to Venturi nozzles, and their description or modelling from the process technology standpoint is based on fundamental correlations and key figures relating to flow mechanics and geometry. The biologically interesting aspect of bubble oscillation is not taken into account in the field of hydrodynamic cavitation. Here it is only the pure intensity, described by the cavitation number, or the bubble collapse pressure that acts as a measure for effectivity.

Cavitation describes the phenomenon of vapour bubble formation by local pressure reduction. It corresponds to the change in the state of a liquid into the gas phase at temperatures below the evaporation temperature. This effect is triggered mainly in already existing micro-gas bubbles or other impurities present in the water such as particles or microbiological cells. The local pressure reduction can be effected by a changing sound pressure (acoustically), or hydrodynamically by an increase in the flow velocity. The result is mostly mixed forms made up of vapour and gas bubbles, or both forms are present in a cavitation bubble. As long as favourable pressure conditions apply for the vapour pressure, or as long as rapidly changing pressure conditions prevail, the bubbles undergo a period of oscillation with rapid and large volume changes. If however the cavitation bubbles return to an area with excess pressure (above vapour pressure), most bubbles collapse under short-term and local heavy pressure and temperature generation. This effect and also the aspheric collapse in the vicinity of fixed surfaces with micro-jet formation lead to the known damage to fluid-flow machines.

With acoustic cavitation, correspondingly changing pressure fields are generated in the water by intensive sound input using a sonotrode or an oscillator. At the minimum pressure levels of these vibrations, the vapour pressure of the liquid is achieved or undershot, resulting in bubble formation and bubble growth. Depending on the pressure amplitude and the frequency, the properties of these vapour and gas mixture bubbles change and either they undergo a phase of oscillation or they collapse. In medical ultrasonic diagnostics and in therapeutic use too, stabilized micro-gas bubbles are used selectively to provide a higher number of initiation gas nuclei or oscillation-capable gas bubbles.

In hydrodynamic cavitation, the initiation and the intensity of cavitation (number and intensity of vapour bubbles) depend mainly on the flow velocity and on local turbulence. Initiation for water and aqueous solutions at 20° C. and in atmospheric pressure conditions is possible even starting from a velocity of 14 m s⁻¹. For liquids other than water, this highly depends on intrinsic factors such as their density, viscosity and vapour pressure. The cavitation tendency and also the intensity of cavitation can be described qualitatively by the dimension-less cavitation number Cᵥ:

$${C}_{v} = \frac{{P}_{∞ } - {P}_{d}}{0 , 5 \cdot ρ \cdot {V}_{∞}^{2}}$$

The cavitation number Cᵥ depends on the difference from ambient pressure Pₒₒ and vapour pressure P_{d}, divided by the density p of the liquid and its maximum velocity V_{∞} in the flow onto or around a component. Above Cᵥ≈1, the onset of cavitation must be expected, and for decreasing values of Cᵥ the probability and then the intensity of cavitation increase.

A turbulence-dependent and pulsating generation of cavitation at appropriate surfaces and flow separations or vortices is often characteristic for hydrodynamic cavitation. This generation merges, looking outwards, into an apparently continuous cavitation. The reality however is that mostly swarms of bubbles and bubble fields are being separated in high frequency at appropriate surfaces or edges until a new front builds up again. This leads to an actually non-homogeneous and discontinuous impact on the flow, applying cavitation and/or vapour bubbles.

A cavitation-induced temporary perforation of tissue cells is known from the results of medical ultrasound research and is for example used to infiltrate substances into cells. In so doing however, the extent of a bubble oscillation close to the cell (rapid periodic volume changes caused by appropriate frequency and amplitude of the ultrasound) and the highest possible number and homogeneous distribution of bubble nuclei play a more important role than individual radical bubble collapses. The bubbles are often made available as stabilized micro-bubbles or also in known manner as ultrasound contrasting agents. These micro-bubbles are excited by ultrasound of suitable intensity and frequency. Thanks to the rapid oscillations and pressure fluctuations of the oscillating bubbles, the cell membrane can be briefly perforated and hence stable hydrophilic pores created for short periods in the cell membrane. With these pores, a diffusion process or transport of substances into the cell can then be considerably accelerated.

Depending on the intensity of the ultrasound, radical bubble collapses also become evident which can inflict lasting damage or even lethal destruction on the cells.

It is also known that cavitation is suitable for disrupting cells or even specifically destroying the cell envelopes and membranes. The damage to yeast cells, for example, is shown in microscopic images. To date studies have been conducted on cell disruption behaviour and on protein release and/or product release under various process conditions and biochemical influencing factors, such as the state of growth of E. coli.

A method and a device for destroying cellular structures in suspensions of micro-organisms is known from DE 102 14 689 A1. This describes the energetic advantages of hydrodynamic cavitation compared with acoustic cavitation for disintegration of agglomerates of bio-mass, and cell disruption for releasing organic mass for better utilization and/or degradation of waste water sludges. The principle for generating cavitation is here a Laval nozzle with defined cross-sections.

In previously known devices, the cavitation occurs mostly due to flow separation. This results in a temporally non-homogeneous state of vapour bubble formation with a change from three states: build-up of bubble clusters, separation of the flow and the bubble clusters, and brief and homogeneous flow around the component or edge without any bubble formation. The initiative generation of vapour bubbles takes place mostly in the turbulent flow fields in the direct vicinity of flow separation edges. A large proportion of the flow is saved from this initiative generation of cavitation bubbles. It is only the turbulent dynamics of the surrounding bubble clusters that can effect further spontaneous cavitation formation in these zones. Furthermore, known solutions cannot sustain a temporally or even spatially extended oscillation field for bubbles. In previously known methods, the bubble generation is followed by a drastic cross-sectional widening with pressure increase and hence collapse of the bubbles. Hence an efficient cavitation yield with low pressure losses is not possible. Geometries designed as a short gap cause particularly pronounced turbulence fields and friction at tube walls which dissipate much energy, mostly uselessly in the form of friction and heat. For example a constricted area as used in a previously known manner for cavitation bubble generation also acts as a throttle to reduce the static pressure, meaning that at this throttle the energy is primarily destroyed without cavitation formation.

It is an object of the present invention to provide a method and a cavitation reactor using said method for generating hydrodynamic, homogeneous and oscillating cavitation bubbles. The task comprises the optimization of hydrodynamic cavitation in order to generate the most homogeneous possible bubble distribution in a volume of liquid on the one hand, and stable, oscillating bubble fields over adjustable time periods on the other hand. This is intended to achieve a better and also more economical possibility for cell manipulation, reaction promotion or emulsion production in comparison to known methods and devices for hydrodynamic or acoustic cavitation generation. Furthermore, the task also comprises its use for the mixing of liquids and solids for better stabilization or formation of a suspension, and in addition for the size reduction and disagglomeration of particles and for a general increase of reactions requiring extreme mixing and selective energy input, such as catalytic conversion of substances and diffusion-limited reactions.

This object is solved by the combination of the features of the independent Claims. Preferred developments of the present invention become apparent from the sub-claims.

The object is solved by a cavitation reactor for hydrodynamic generation of homogeneous, oscillating cavitation bubbles in a fluid, including, while forming a flow duct and arranged one behind the other in the direction of flow of the fluid, an acceleration section designed to increase a flow velocity, a diaphragm arranged transversely to the direction of flow with a plurality of micro-passages designed for generating cavitation bubbles, where at least 10 micro-passages per cm² are provided over an entire flow cross-sectional surface defined on an oncoming flow side of the diaphragm, a stabilization section designed for stabilizing an oscillation of cavitation bubbles, and a collapse section with at least one widening of a flow cross-sectional surface of the flow duct in the direction of flow. The diaphragm at which cavitation takes place thus includes a very large number of micro-passages or micro-holes. When viewing the diaphragm surface facing the flow, at least 10 of these micro-passages per cm² can be discerned. The micro-passages are advantageously distributed evenly over the complete oncoming flow surface. Upstream of the acceleration section, the pressure of the fluid is furthermore increased relative to a normal pressure at the end of the cavitation reactor, preferably by means of a pump. In the acceleration section, the velocity of the fluid flow is increased preferably many times over.

The new geometry in accordance with the invention optimally combines an energetically efficient generation of cavitation and vapour bubbles that is both spatially and temporally homogeneous. Furthermore, the generated bubble field is kept stable in an area of high flow velocity in a dynamically oscillating state and forced to a final collapse only very late and selectively. The theoretically described requirements for a cell manipulation or membrane perforation by cavitation are thus met to a very high degree.

In an advantageous embodiment of the cavitation reactor it is provided that the flow cross-sectional surface steadily narrows in the acceleration section in the direction of flow. For operation of the cavitation reactor, a constantly running pump upstream of the acceleration section is thus used. The fluid is then accelerated by the narrowing flow cross-section in front of the diaphragm.

It is furthermore advantageous that the acceleration section includes an internal nozzle cone narrowing in the direction of flow and extending up to the diaphragm, so that the flow cross-sectional surfaces in the acceleration section and the flow cross-sectional surface of the diaphragm contacting the oncoming flow are annularly designed. The diaphragm can be advantageously fastened to the end of this nozzle cone, permitting a stable mounting of the diaphragm. Furthermore, the nozzle cone permits a very severe narrowing of the flow cross-sectional surface in the acceleration section.

It is furthermore preferred that the nozzle cone converges upstream of the acceleration section to a tip pointing against the direction of flow. Due to this tip pointing against the direction of flow, the oncoming fluid flow is split as turbulence-free as possible in annular form.

In a further preferred embodiment of the cavitation reactor, it is provided that the acceleration section for generating a swirl in the fluid includes helical wall elements. With a helical flow guidance of this type, a swirl is obtained for better mixing of the flow lines. Furthermore, mixing of the main fluid with the disinfecting fluid is improved, for example when a disinfecting fluid is admixed upstream of the diaphragm.

In a further preferred embodiment, it is provided that the flow cross-sectional surface decreases over the acceleration area, i.e. from the beginning of the acceleration area to the beginning of the diaphragm, by 70% to 99%, in particular 80% to 96%, in particular 90% to 93%. This assures a very strong acceleration of the fluid, which is necessary for generating cavitation bubbles.

It is further preferred that the flow cross-sectional surface of the preferably annular diaphragm contacting the oncoming flow has at least 26, in particular at least 50, in particular at least 100, in particular at least 150, in particular at least 200 micro-passages. The more micro-passages the diaphragm has, the more flow separation edges are available for cavitation bubble formation.

In a further advantageous embodiment of the cavitation reactor, the micro-passages have in each case a passage surface of <3 mm², in particular <2 mm², in particular between 0.01 mm² and 1 mm², in particular between 0.1 mm² and 0.2 mm². The passage surface of the micro-passages must be measured when viewed vertically to the flow cross-sectional surface of the diaphragm contacting the oncoming flow, with the clear passage surface being crucial here. It is essential here that most micro-passages match the sizes stated. Slight divergences or individually larger micro-passages do not militate against the advantageous generation of cavitation bubbles in accordance with the invention and are hence also to be regarded as preferred embodiments or even deliberately designed in order to generate homogeneously different sizes of bubbles and bubble fields, provided a numerically even distribution of the previously described sizes for the micro-passages is assured over the entire diaphragm plane.

It is further preferred that over the entire flow cross-sectional surface defined on the oncoming flow side of the diaphragm at least 20, in particular at least 50, in particular at least 100, in particular at least 200, in particular at least 1000 micro-passages per cm² are provided. The more micro-passages are provided per oncoming flow surface, the more flow separation edges are available for cavitation bubble formation. In particular with an extremely large number of flow separation edges, bubble and cavitation generation fluctuates over more micro-passages and the bubble clusters separate at very different times, so that a cavitation bubble field is created which is in effect spatially and temporally stationary and homogeneous.

It is further preferred that the micro-passages of the diaphragm are designed round or angled, in particular square or rhomboidal. Thanks to the differing design of the micro-passages, a certain number of micro-passages per surface of a given size can be arranged. It is here preferred both to provide micro-passages of differing form inside a diaphragm and to design a diaphragm with micro-passages exclusively in one form.

In a further preferred embodiment, it is provided that 25% to 65%, in particular 35% to 55%, in particular 40% to 50% of the flow cross-sectional surface of the diaphragm contacting the oncoming flow is taken up by the clear passage surface of the micro-passages. This ensures that on the one hand a very large number of flow separation edges is available for cavitation formation, and on the other hand the diaphragm exerts relatively little resistance to the flow due to a large proportion of micro-passages. As a result, the energy input of the entire system is reduced.

It is further preferred that the diaphragm is designed as a micro-grid or micro-fabric. Thanks to the use of a micro-grid or micro-fabric, a very large number of small micro-passages can be concentrated on a very narrow space. Advantageously, a material with a diameter of 0.01 mm to 1.0 mm, in particular of 0.1 mm to 0.3 mm, in particular of 0.2 mm is used for the micro-grid or micro-fabric. The preferred micro-passages have a mesh width of 0.1 mm to 1.7 mm, in particular 0.2 mm to 0.8 mm, in particular 0.4 mm. The mesh width is defined here as the clear width of the mesh. With a square design of the micro-passages, the mesh width is thus the clear width between two adjacent parallel wires or fabric threads. Further embodiments can provide rhomboidal and entirely parallel orientation of the micro-passages in the diaphragm plane. Parallel wires or rods are preferably used here. A metal wire with round or angular or triangular cross-section is particularly preferred for use as the material of the micro-grid or micro-fabric. Thanks to the particular design of the wire cross-section, the condition of cavitation and in particular the turbulence and vortex formation and hence the separation of the cavitation bubbles from the grid can be influenced. In a preferred embodiment, the wire used has an equilateral and triangular cross-section, the wire being arranged in the grid such that the tip of the triangle turns against the direction of flow, thus splitting the flow along the two sides.

Alternatively to the embodiment of the diaphragm as a micro-grid or micro-fabric, it is preferred to design the diaphragm as a micro-hole plate; in particular for large flow cross-sections the more stable micro-hole plate can be used for preference instead of the micro-grid or micro-fabric. The micro-passages can also here have the above described properties, be of square, rhomboidal or rectangular shape, or be designed as one-dimensional gaps. The axial design can also be preferably in the form of triangles tapering in the direction of flow. The thickness of the micro-hole plate should here be preferably 0.1 to 50 times the diameter or edge length of a square or rectangular micro-passage, in particular 0.3 to 5 times, in particular 0.5 to 2 times. Alternatively to this, it is also possible to reinforce a micro-grid or micro-fabric preferably with rods, so that this design too can be stably applied for large flow cross-sections. A porous material must be stated as a further preferred embodiment, allowing a porous material also to form the diaphragm instead of micro-hole plates or micro-grids. In particular, extremely small micro-passages on a very narrow space can be provided here.

In a further preferred embodiment of the cavitation reactor in accordance with the invention, the flow cross-sectional surface slightly increases over the stabilization section or is constant throughout. This only very slight change in the flow cross-section or the constant flow cross-section does not prevent a minor and abrupt cross-sectional widening shortly downstream of the diaphragm due to a design embodiment.

It is particularly preferred that the flow cross-sectional surface at the beginning of the stabilization section corresponds to 100% to 200%, in particular to 110% to 150%, in particular to 120% to 130% of the flow cross-sectional surface of the preferably annular diaphragm contacting the oncoming flow. The widening relative to the surface of the micro-passages, that can be passed by the flow, is here preferably 200%-1000%, in particular 250%-600%, in particular 280%-300%. The axial length of this stabilization section is preferably 3 to 75 times, preferably 5 to 45 times, preferably 7 to 15 times the tube diameter of this section. Due to this relatively minor widening downstream of the diaphragm, the cavitation bubbles on the one hand are kept stably oscillating and on the other hand the cavitation bubbles have sufficient space to spread out homogeneously.

By contrast, the flow cross-sectional surface widens in the collapse section directly adjoining the stabilization section. It is preferred here that the flow cross-sectional surface in the collapse section widens in a large stage by 10-30 times the flow surface of the stabilization section and/or widens in several small stages, preferably in the stages from 0.01 to 1 times, in particular by 0.1 to 0.3 times the diameter of the stabilization section and/or with a constant opening angle and/or with various continuously or uncontinuously merging opening angles, preferably angles from 2°-20°, in particular angles from 4°-10°. A defined and discrete end of the cavitation bubbles can also be achieved especially by the provision of various stages of widening.

This widening of the flow cross-section or of the flow cross-sectional surfaces in the collapse section can be either radially symmetrical or helical. With the helical embodiment, the edge then follows for example at one of the stages a helical generating line of the collapse section.

Furthermore, it is preferred that the cavitation reactor includes an upstream section arranged in the direction of flow directly in front of the acceleration section with flow straighteners for calming the fluid. The already described nozzle cone tip pointing in the direction of flow extends here into this upstream section.

The invention furthermore provides a method for hydrodynamic generation of homogeneous, oscillating cavitation bubbles in a fluid, comprising the following steps in the stated sequence: acceleration of the fluid, fluid flowing onto a diaphragm having a plurality of micro-passages with the fluid for generating cavitation bubbles, where at least 10 micro-passages per cm² are formed over the entire flow cross-sectional surface defined on an oncoming flow side of the diaphragm, stabilization of an oscillation of the cavitation bubbles, and widening of a flow cross-sectional surface of the fluid along the direction of flow in order to collapse the cavitation bubbles.

The advantageous embodiments as discussed with reference to the cavitation reactor in accordance with the invention are of course also applied accordingly to the method in accordance with the invention for hydrodynamic generation of homogeneous, oscillating cavitation bubbles in a fluid.

The invention furthermore provides a method for disinfection of a fluid, comprising the just-described method for hydrodynamic generation of homogeneous, oscillating cavitation bubbles, where the fluid mixes with disinfectant, in particular disinfecting fluid before flowing to the plurality of micro-passages. In a particularly preferred embodiment, it is provided that before mixing of the fluid with disinfectant and/or after widening of the flow cross-section a germ number in the fluid is determined. As a result, it can in particular be measured whether sufficient germs have been killed by cavitation. The fluid circulation can preferably be controlled on the basis of these measurements. It is thus possible to regulate preferably the adjustment of the cavitation conditions and the quantity of disinfectant, as well as a new cycle of the cavitation reactor that may be required or a cycle of a further cavitation reactor connected downstream.

The already discussed advantageous embodiments of the cavitation reactor in accordance with the invention are of course also applied appropriately to the method in accordance with the invention for disinfection of a fluid.

The invention furthermore provides a method for emulsifying or suspending or reaction-promoting of at least two substances, in particular two liquids or a liquid and a solid or a liquid and a gas, comprising the already described method for hydrodynamic generation of homogeneous, oscillating cavitation bubbles, where the fluid is, before flowing onto the diaphragm, made up of the at least two different substances. In particular, the fluid is mixed with ethanol and/or water and/or an auxiliary substance. Thanks to cavitation, very small units of the liquids and/or solid particles to be mixed can be swirled around so that reduction in size of the droplets and/or solid units is achieved that leads to a stable emulsion or suspension. Furthermore, the boundary surface between two liquids increases due to the cavitation, so that these can optimally react with one another or the transport of substances over the phase boundary is favoured.

The already described advantageous embodiments of the cavitation reactor in accordance with the invention are of course also applied appropriately to the method for emulsifying or for reaction-promoting of diffusion-limited or catalytic reactions, which are positively influenced by a high degree of mixing and turbulence, and also for influencing biological materials, in particular biological cells and their cell envelopes and membranes.

The idea of energetically effective generation of temporally and also spatially homogeneous cavitation bubble fields and its optimum technical implementation form the core of this invention. The use of hydrodynamically generated bubble oscillations for cell perforation is thus not least possible thanks to the new approach to flow guidance and to the combination of hydrodynamic properties with deliberately used technical elements. The transfer of the basic knowledge from medical ultrasound research relating to the biological effect of oscillating bubbles into cell manipulation by means of hydrodynamic cavitation required a number of new design approaches, since on the one hand the generation of homogeneous bubble fields cannot be achieved, as in ultrasound research, by selective addition of micro-bubbles, and on the other hand the dwell time and intensity cannot be controlled by the amplitude and frequency of an ultrasound radiator. These properties are however brought to a technically feasible solution in accordance with the invention by a selective combination of physical and fluidic concepts.

The cell-perforating effect of oscillating cavitation bubbles can advantageously be used in practice in a combination with disinfectants. Most disinfectants can pass the membrane of the cell not at all or only with a high diffusion pressure and/or high concentration. The effect is thus limited to the surface, although the best place of action would be in the bacterial cell, e.g. on the DNA or RNA or intracellular enzymes and enzyme complexes, and would there lead more quickly to lethal inactivation. In particular, a combination of chlorine dioxide with oscillating cavitation is advantageous. An increase in inactivation takes place here, since the chlorine dioxide can diffuse better and faster to the place of action in the cell due to the transient perforation of the cell membrane. Preferably, the disinfectant is metered from a reserve by means of a metering pump into the main flow in an adjusted quantity before the pressure increase. Inside the pump an ideal pre-mixing of the disinfectant is already achieved here. After the pressure increase, the cavitation reactor is passed and then an appropriate dwell time leading to the required inactivation is granted.

The invention furthermore provides a method for hydrodynamically generated short-term cell and membrane manipulation, comprising the method for hydrodynamic generation of homogeneous, oscillating cavitation bubbles, in the manner of transient membrane perforation for increasing permeability for all substances that would otherwise have little or no permeability.

The already discussed advantageous embodiments of the method in accordance with the invention for hydrodynamic generation of homogeneous, oscillating cavitation bubbles are of course also applied appropriately to the method in accordance with the invention for hydrodynamically generated short-term cell and membrane manipulation.

The present invention is more fully described in light of the accompanying drawing showing a preferred embodiment. In the drawing,

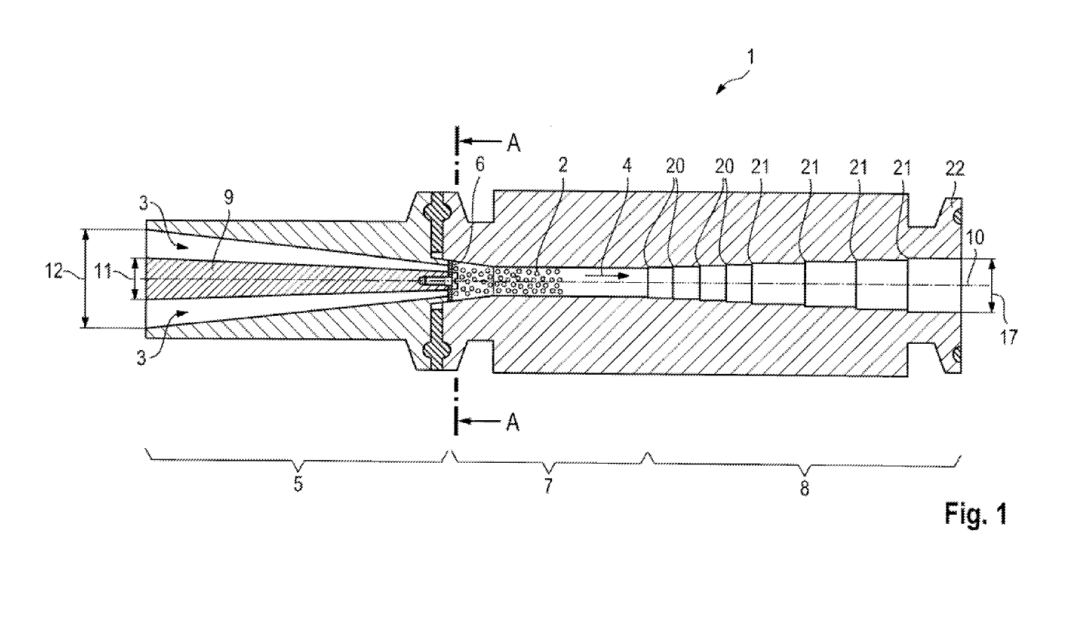

FIG. 1 shows a cavitation reactor in accordance with the embodiment,

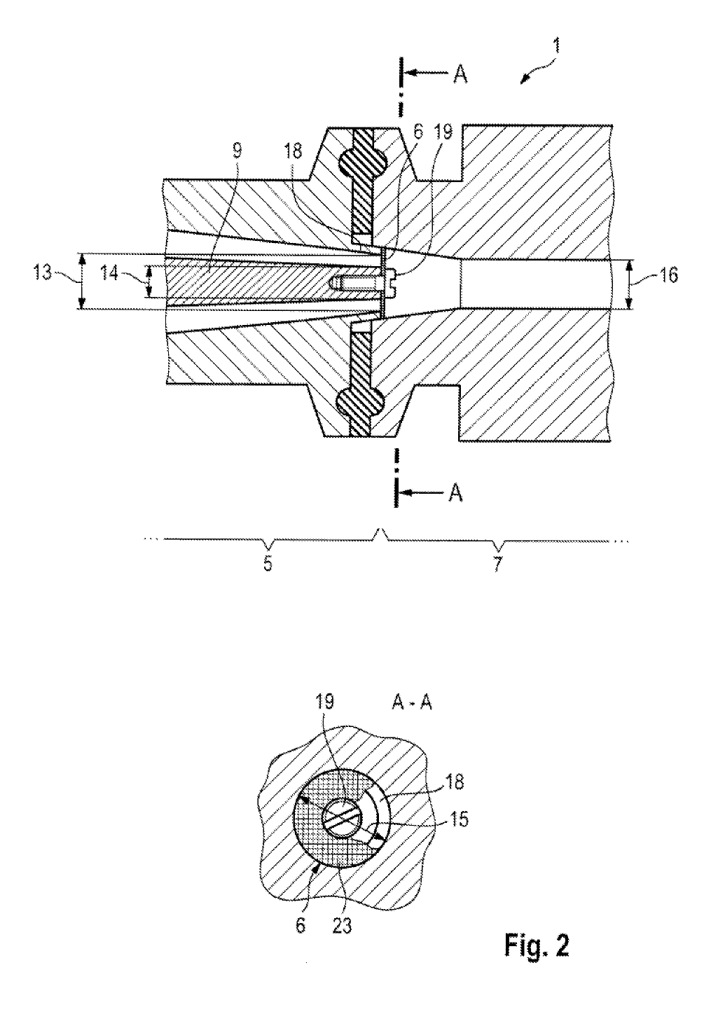

FIG. 2 is a detail view including a sectional view of the cavitation reactor in accordance with the embodiment,

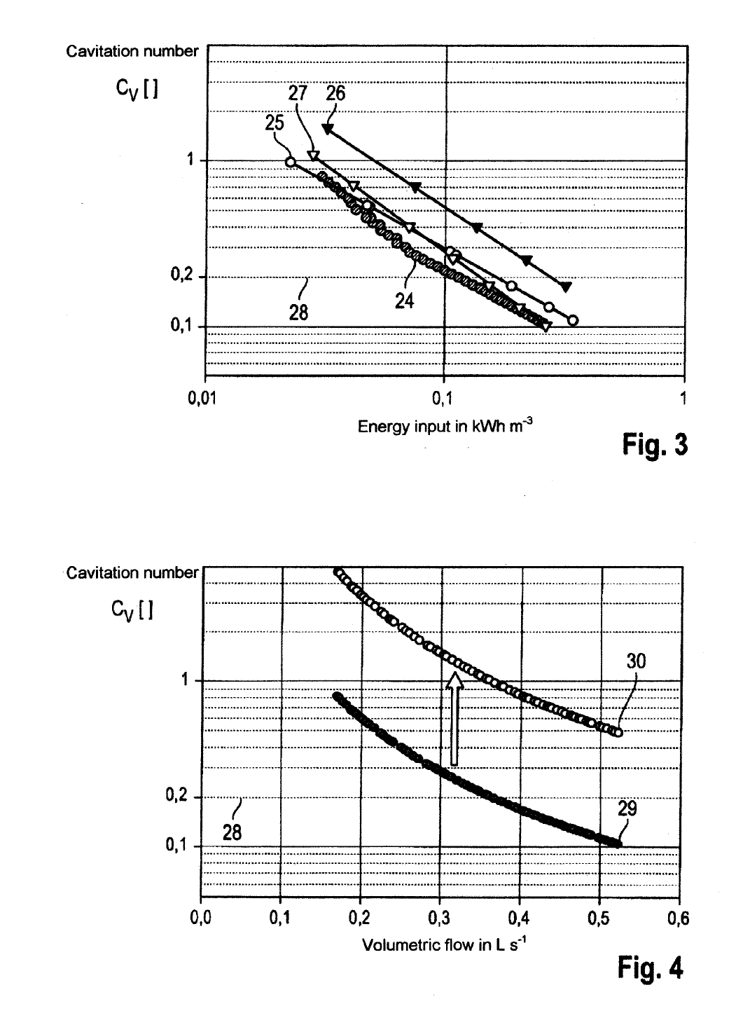

FIG. 3 is a comparison between the cavitation reactor in accordance with the embodiment and other options for cavitation generation,

FIG. 4 represents the cavitation number as a function of the volumetric flow in the cavitation reactor in accordance with the embodiment,

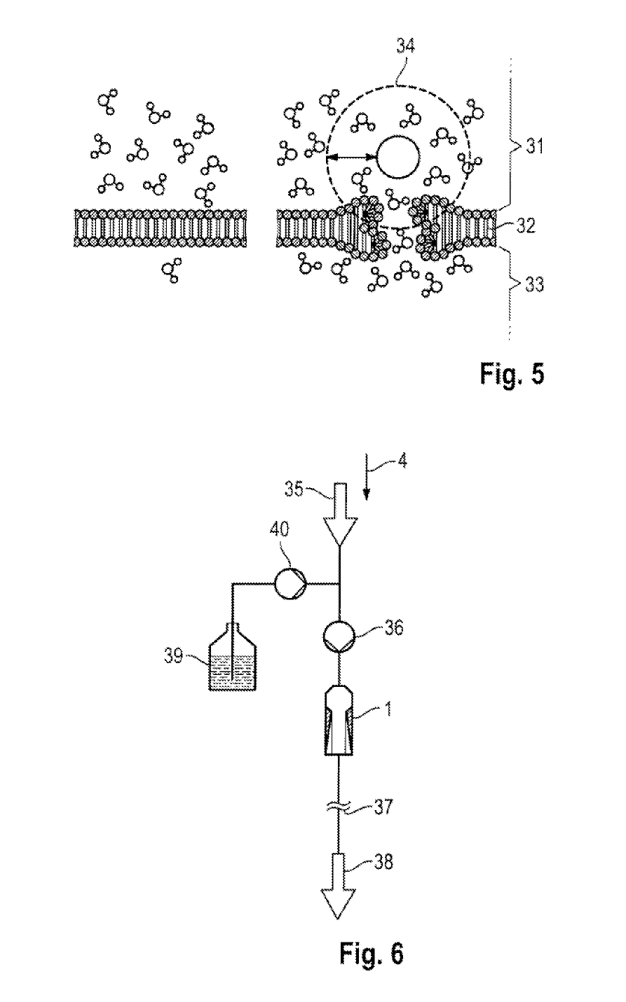

FIG. 5 shows a schematic representation of cell perforation by means of the cavitation reactor in accordance with the embodiment,

FIG. 6 provides a method for disinfection of a fluid by means of the cavitation reactor in accordance with the embodiment, and

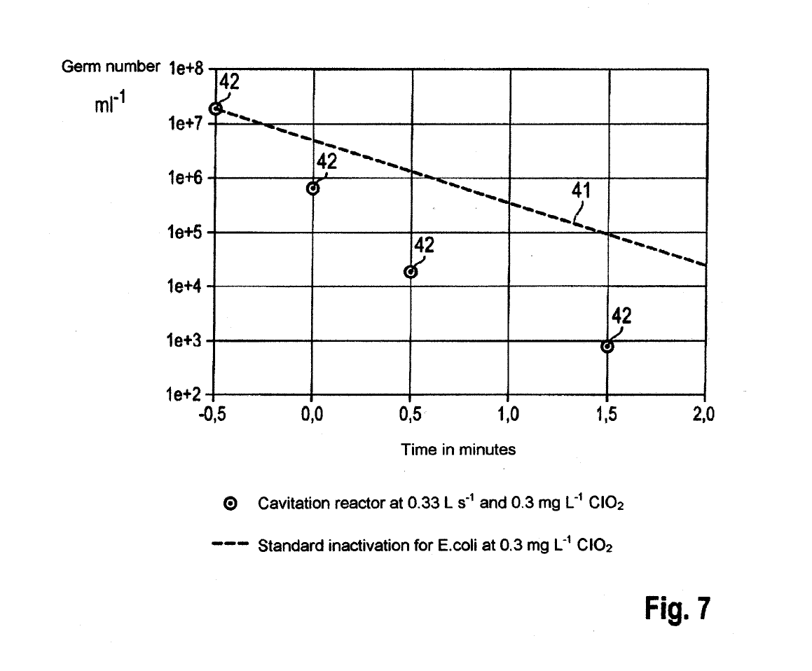

FIG. 7 shows a diagram illustrating the efficiency of disinfection by means of the cavitation reactor in accordance with the embodiment.

FIG. 1 shows a cavitation reactor 1 in accordance with the embodiment. The application relates to aqueous solutions selectively inoculated with bacteria. The dimensioning of the reactor was effected here for a pilot laboratory scale. The treatable volumetric flows vary here from 0.3 L s⁻¹-0.5 L s⁻¹ with pressure losses of 2.5 bars to 10 bars. The system is designed open and hence is exposed to atmospheric pressure. The temperature of the aqueous solution here was 20° C. The tube cross-section upstream and downstream of the cavitation reactor is here 20 mm. Both the reactor and the upstream and downstream sections are made of hydraulically smooth special steel (V4A, surface roughness<2 μm). The cavitation reactor 1 in FIG. 1 includes here, arranged in a direction of flow 4, an acceleration section 5, a diaphragm 6 vertical to the direction of flow 4, a stabilization section 7 and a collapse section 8. The acceleration section 5, the diaphragm 6, the stabilization section 7 and the collapse section 8 are directly adjacent to one another and form a flow duct 3. Inside this flow duct 3 the fluid flows from the acceleration section 5 to the collapse section 8. Cavitation bubbles 2 are generated here at the diaphragm 6. These cavitation bubbles 2 are extremely small and can therefore only be shown in schematic form in FIG. 1.

The acceleration section 5 includes a nozzle cone 9. This nozzle cone 9 is used for further narrowing of the flow cross-section along the direction of flow 4 and is arranged rotation-symmetrical to a central axis 10 of the flow duct 3. The nozzle cone 9 ends directly at the beginning of the diaphragm 6. This makes it possible that the diaphragm 6 can be screwed using a bolt 19 (FIG. 2) onto the end face of the nozzle cone 9. With its outer circumference, the diaphragm 6 rests on a grid stop 18 (FIG. 2).

The collapse section 8 initially includes four smaller successive stages 20 and then four larger successive stages 21 for cross-sectional widening. The end of the collapse section 8 is designed as a flange 22.

FIG. 2 shows a section of the cavitation reactor 1 in accordance with the embodiment and a section A-A. In the sectional view, it can be readily seen that the diaphragm 6, designed as a micro-grid, rests in the centre on the nozzle cone 9 and is bolted there. An outer circumferential edge of the diaphragm 6 rests on the grid stop 18. As a result, a cross-sectional oncoming flow surface of the diaphragm 6 in annular form is created between the grid stop 18 and the nozzle cone 9.

FIGS. 1 and 2 furthermore show the following diameters: a first diameter 11 shows an initial diameter of the nozzle cone 9 at the beginning of the acceleration section 5. A second diameter 12 shows, also at the beginning of the acceleration section 5, the maximum internal diameter of the acceleration section 5. This second diameter 12 narrows along the direction of flow 4 up to the end of the acceleration section 5 into a third diameter 13. The first diameter 11 narrows along the direction of flow 4 up to the end of the nozzle cone 9 or to the end of the acceleration section 5 into the fourth diameter 14. The difference between the third diameter 13 and the fourth diameter 14 defines an annular surface. This annular surface is in turn the flow cross-sectional surface of the diaphragm 6 contacting the oncoming flow. Furthermore, the section in FIG. 2 shows a total diameter 15 of the inserted diaphragm 6. Since however the diaphragm 6 rests both on the grid stop 18 and on the nozzle cone 9, only some of the micro-passages 23 can be counted towards the flow cross-sectional surface of the diaphragm 6 contacting the oncoming flow, and also only this part of the micro-passages 23 is used for cavitation bubble formation.

The stabilization section 7 is designed with a substantially constant sixth diameter 16. This sixth diameter 16 then increases abruptly along the collapse section 8 up to the seventh diameter 17 at the end of the collapse section 8.

The geometry represented in FIGS. 1 and 2 effects, unlike all other known apparatuses and geometries, the already described advantageous generation of homogeneous, oscillating cavitation, for example for membrane perforation or cell manipulation.

After an acceleration of the flow in the smoothly narrowing nozzle with low pressure loss due to stagnation points, the passage takes place at a high flow velocity through a small annular gap on the diaphragm 6, designed as a micro-grid, over the entire cross-section.

The fine structure of this grid now causes fine cavitation bubbles 2 and bubble clusters, homogeneously distributed over the entire annular gap. Since the generation of individual bubbles takes place at many different fine grid points, neither a periodic separation of the entire flow nor a temporally non-homogeneous cavitation generation results. Instead there is a fluctuative formation of bubble swarms over the entire grid area which mix in the downstream section or in the stabilization section 7 into a temporally homogeneous distribution. This stabilization section 7 is designed initially as a tube section with further constant and narrow cross-section for keeping the flow velocity high enough. Thus the static pressure remains low enough to keep the oscillating cavitation bubbles 2 stable. The cavitation bubbles 2 thus have a longer dwell time inside the apparatus and can also undergo several hundred oscillations. The exit or the collapse section 8 is designed with a slow cross-sectional widening in which the static pressure rises again and the cavitation bubbles 2 are finally forced to collapse. Depending on the flow velocity, this area falls on increasingly larger cross-sectional areas, and/or the area of bubble oscillation is prolonged. In this collapse section 8, the typical pressure waves as known from conventional cavitation generation are released. As a result, high energies and shear stresses are additionally provided for a short time.

In a preferred expansion of the cavitation reactor 1 in accordance with the embodiment, it is provided that in the direction of flow 4 in front of the acceleration section 5 an upstream section is provided, in which the splitting and the calming of the volumetric flow onto the annular gap take place by means of a tip and/or by means of flow straighteners. This is preferably done with a diameter of about 20 mm over a length of 75 mm.

The first diameter 11 is in the embodiment 10 mm, the second diameter 12 is 20 mm, the third diameter 13 is 6.4 mm and the fourth diameter 14 is 4 mm. The acceleration section 5 extends here over a length of 75 mm.

The mesh width used in the micro grid of the diaphragm 6 is 0.4 mm with a wire thickness of 0.2 mm in the embodiment. The result is a free grid surface of 44%. For sufficient stabilization of the bubble oscillation, the sixth diameter 16 is 5.6 mm and the stabilization section 7 extends over 40 mm. The four small stages 20 of the collapse section 8 increase the cross-section every 5 mm in stages of 0.2 mm. The large stages 21 increase the cross-section every 10 mm in stages of 1 mm.

Supplementing the variant shown of the cavitation reactor 1, an exit section with an initial diameter of 10 mm and widening to 20 mm can preferably be provided at the flange 22 at the end of the collapse section 8.

Furthermore, the cross-sectional rise in the collapse section 8 can in particular be designed preferably helical, so that a very gentle pressure increase is achieved and thus an elongated collapse zone is provided in the axial direction.

Despite the complex structure of this new type of cavitation reactor 1, it is attractive thanks to a very efficient way of converting energy into cavitation and long and stable bubble fields. At the right operating point, it requires a pressure difference of only 3.0-3.5 bars.

FIG. 3 compares the energetic efficiency of the cavitation reactor in accordance with the invention with other types of cavitation generators of similar dimensions with regard to volumetric flow and free cross-sectional surface. FIG. 3 shows here a plot of the achievable cavitation number C, as a function of the hydraulic power to be provided in kWh per m³ of treated water. This allows the efficiencies of cavitation apparatuses to be readily compared also for various volumetric flows, since in this plot the pressure loss and the volumetric flow are linked and the efficiency can be read off directly at the achievable cavitation number. The hydraulic power corresponds here to the product of volumetric flow and pressure loss. The lower the Cᵥ values achievable with the lowest possible energy input, the better the conversion of energy into cavitation, i.'e. the further to the left and below in FIG. 3 the corresponding curve is, the more effective is the associated cavitation generation.

The first curve 24 shows the measurement at the cavitation reactor 1 in accordance with the invention as per the embodiment. The second curve 25 shows a cavitation with a 12-hole diaphragm designed for comparison purposes, where for each hole a diameter of 1.0 mm is provided and a free throughflow surface of 9.5 mm² results. A third curve 26 shows measurement results of a hole diaphragm with only one hole and a diameter of 3.3 mm, and hence a free throughflow surface of 8.6 mm². A fourth curve 27 shows measurement results with a conventional Venturi nozzle with a used diameter of 3.3 mm and a length of 100 mm. With a cavitation number of 0.2, an operating point 28 of the cavitation reactor 1 as per the embodiment is shown.

The comparison shows that the cavitation reactor 1 in accordance with the invention has at the operating point 28 (Cᵥ˜0.2) a markedly higher efficiency in its cavitation yield than a hole diaphragm with few and large holes or than a simple Venturi nozzle. Similar efficiencies are only achieved with very high volumetric flows and energy inputs. The described advantages of homogeneous, oscillating bubble fields are however achieved only by the variant in accordance with the invention.

The diagram in FIG. 4 shows a measurement at the cavitation reactor 1 as per the embodiment and represents here the cavitation number Cᵥ as a function of the volumetric flow in Ls⁻¹. A fifth curve 29 shows pressure-corrected values of the cavitation number Cᵥ at the diaphragm 6. A sixth curve 30 shows the course of the cavitation number as a function of the volumetric flow in the cavitation reactor 1 at the end of the stabilization section 7 with a diameter 6 of 5.6 mm.

The higher efficiency at the operating point 28 is due to the particular property of homogeneous bubble generation in the grid plane. As shown in FIG. 4, the operating point 28 is, with a volumetric flow of approx. 0.32 L/s with complete cavitation formation, in the stabilization section 7. In this operating point 28, a normal Venturi nozzle with a diameter of 5.6 mm (similar to the sixth diameter 16) would not yet cavitate. The Cᵥ value would still be too high at approx. 1.3 and the cavitation would not yet start.

During operation of the cavitation reactor 1 in accordance with the invention, it is clear when using different volumetric flows that above around 0.2 L/s cavitation starts from diaphragm 6. If the volumetric flow is increased to a value of 0.315 L/s, cavitation expands abruptly from the grid plane to far into the stabilization section 7, although this would theoretically not yet be possible with a cavitation number of approx. 1.4 for this area. Only after the first widenings of the collapse section 8 the bubbles 2 are forced to collapse. Until then, a homogeneous field of oscillating cavitation bubbles 2, which is even maintained under non-cavitative conditions, extends up to there. If the volumetric flow is further increased, the cavitation zone extends ever further into the opening cone. The bubble collapse then takes place for example only in the area of the 7.0 or 8.0 mm cross-section.

The cell perforating effect of oscillating cavitation bubbles 2 can be practically applied in combination with disinfectants. Most disinfectants can pass the membrane of the cell not at all or only with a high diffusion pressure or high concentration. The effect is thus restricted to the surface of the cell, although the best place of action would be in the bacterial cell, e.g. on the DNA or RNA or intracellular enzymes and enzyme complexes and would there lead more quickly to lethal inactivation.

FIG. 5 shows a schematic representation of cell perforation using hydrodynamic cavitation. In this case a cell membrane 32 is shown. Outside the appropriate cell is the outer area 31. Inside the cell is the inner area 33. Furthermore, the right-hand area of FIG. 5 shows an oscillating bubble 34 with minimum diameter and maximum diameter represented by a dashed line. By oscillation of the bubble 34, the cell membrane 32 is opened at least temporarily so that the agent can penetrate into the inner area 33 or flow out from the inner area 33 into the outer area 31.

Using the example of chlorine dioxide, this was also confirmed at the chair for biochemical engineering of TU-München in tests with Escherichia coli. FIG. 5 illustrates the mechanism on which the increase in inactivation efficiency is based. By the combination of chlorine dioxide with oscillating cavitation, an increase in inactivation can be observed, since the chlorine dioxide can diffuse better and more quickly to the place of action in the cell thanks to the transient perforation of the cell membrane 32.

FIG. 6 shows a schematic process sequence for disinfection of a fluid by means of the cavitation reactor 1 as per the embodiment. Along the direction of flow 4, a first sampling point 35 is initially provided for determining the germ number and then a pressure increasing device 36. The cavitation reactor 1 follows downstream of this pressure increasing device 36, designed as a pump. Downstream of the cavitation reactor 1 a holding/application time 37 is provided. Finally there is a second sampling point 38 for determining the germ number after cavitation. Between the first sampling point 35 and the pressure increasing device 36, chlorine dioxide is introduced as a disinfectant 39 from a supply container into the main fluid flow by means of a metering pump 40.

The principle of the process sequence is shown in FIG. 6. Before the pressure is increased, the disinfectant 39 is metered from a reserve by means of the metering pump 40 into the main flow, in an adjusted quantity. An ideal pre-mixing of the disinfectant 39 already takes place here inside the metering pump 40. Downstream of the pressure increasing device 36, the cavitation reactor 1 is passed and then the appropriate holding/application time 37, leading to the required inactivation, is granted.

FIG. 7 shows a diagram with the germ number in colony-forming units ml⁻¹ as a function of time in minutes to illustrate the efficient disinfection method according to FIG. 6. The dashed line 41 in FIG. 7 shows a specific inactivation rate in accordance with the standard inactivation for E. coli at 0.3 mg L⁻¹ of chlorine dioxide. The four measurement points 42 by contrast show the measurement results when the method according to FIG. 6 is used.

With the results according to FIG. 7, it can be shown that after the passage through the cavitation reactor 1 a higher inactivation is achievable than in treatment solely with chlorine dioxide 39. A comparison was made of the post-incubations, i.e. the temporal inactivation after passage of the cavitation reactor 1 (Cᵥ=0.2 at 0.32 L s⁻¹) with the inactivation rate 41 of 0.85 min⁻¹ (according to the literature the concentration-time-specific inactivation for 99% killing at 20° C. for E. coli and chlorine dioxide of 0.70 min*mg L⁻¹), taking into account identical reaction conditions. It is shown that by the combination of chlorine dioxide 39 with cavitation the inactivation rate is considerably increased and the 2.3 times inactivation of 2.0 per minute is achieved, or with less than half the concentration of chlorine dioxide 39 the same effect can be achieved (the measured concentration-time-specific inactivation for 99% killing is 0.30 min*mg L⁻¹).

With the combination of chlorine dioxide 39 and the cavitation reactor 1 in accordance with the invention, more than 50% of chlorine dioxide 39 can be saved. The energy costs to be calculated (approx. 0.015 ε/m⁻³ of process water) and the investment costs are low in comparison to the savings for chemical costs. By optimization of the process conditions and process control, the quantity used of chlorine dioxide 39 can be further reduced. This therefore opens up a wide range of uses for many further fields of sterilization of process waters which to date still require excessive or undesirable quantities of disinfectants. From the ecological viewpoint, there are some advantages not only for chlorine dioxide 39 but also in general, in combination with other disinfectants too. For example it can be stressed that there is a lower environmental impact, both from the manufacture of chemicals and from pollution during and after the application. The chemical impact of the process water is reduced by half, so that far fewer side-reactions with damaging product formation take place. For many disinfectants, handling and storage is also simplified.

1. A cavitation reactor for hydrodynamic generation of substantially homogeneous, oscillating cavitation bubbles, comprising a flow duct that includes
an acceleration section configured to increase a flow velocity of a flow of a fluid,
a diaphragm arranged proximate the acceleration section in the direction of the flow and transversely to the direction of the flow, the diaphragm having a plurality of micro-passages configured to generate cavitation bubbles, wherein at least 10 micro-passages per cm² are provided over an entire flow cross-sectional surface defined on an oncoming flow side of the diaphragm,
a stabilization section that is arranged proximate the diaphragm in the direction of the flow and configured to stabilize an oscillation of cavitation bubbles, and
a collapse section that is arranged proximate the stabilization section in the direction of the flow and has at least one widening of a flow cross-sectional surface of the flow duct in the direction of the flow.

2. The cavitation reactor in accordance with claim 1, wherein a flow cross-sectional surface of the acceleration section steadily narrows in the acceleration section in the direction of the flow.

3. The cavitation reactor in accordance with claim 2, wherein the acceleration section includes an internal nozzle cone narrowing in the direction of the flow and extending up to the diaphragm, so that the flow cross-sectional surface in the acceleration section and the flow cross-sectional surface of the diaphragm contacting the oncoming flow are annularly designed.

4. The cavitation reactor in accordance with claim 3, wherein the nozzle cone converges upstream of the acceleration section to a tip pointing against the direction of the flow.

5. The cavitation reactor in accordance with claim 1, wherein the acceleration section for generating a swirl in the fluid includes helical wall elements.

6. (canceled)

7. The cavitation reactor in accordance with claim 1, wherein the flow cross-sectional surface of the diaphragm contacting the oncoming flow has at least 26, in particular at least 50, in particular at least 100, in particular at least 150, in particular at least 200 micro-passages.

8. The cavitation reactor in accordance with claim 1, wherein the micro-passages have in each case a passage surface of <3 mm², in particular <2 mm², in particular between 0.01 mm² and 1 mm², in particular between 0.1 mm² and 0.2 mm².

9. The cavitation reactor in accordance with claim 1, wherein over the entire flow cross-sectional surface defined on the oncoming flow side of the diaphragm at least 20, in particular at least 50, in particular at least 100, in particular at least 1000 micro-passages per cm² are provided.

10. The cavitation reactor in accordance with claim 1, wherein the micro-passages of the diaphragm are designed round or angled, in particular square or rhomboidal, and/or in the form of one-dimensional parallel slots.

11. The cavitation reactor in accordance with claim 1, wherein 25% to 65%, in particular 35% to 55%, in particular 40% to 50% of the flow cross-sectional surface of the diaphragm contacting the oncoming flow is taken up by the micro-passages.

12. The cavitation reactor in accordance with claim 1, wherein the diaphragm is designed as a micro-grid or micro-fabric.

13. The cavitation reactor in accordance with claim 12, wherein a material of the micro-grid or micro-fabric has a diameter of 0.01 mm to 1.0 mm and the micro-passages have a mesh width of 0.1 mm to 1.7 mm.

14-15. (canceled)

16. The cavitation reactor in accordance with claim 1, wherein the flow cross-sectional surface is constant over the stabilization section or slightly steadily increases in the direction of the flow.

17. The cavitation reactor in accordance with claim 1, wherein a flow cross-sectional surface of the stabilization section at the beginning of the stabilization section corresponds to 100% to 200% of the flow cross-sectional surface of the diaphragm contacting the oncoming flow.

18. The cavitation reactor in accordance with claim 17, wherein the flow cross-sectional surface of the stabilization section at the beginning of the stabilization section corresponds to 200% to 1000% of a surface of all micro-passages that can be passed by the flow.

19. The cavitation reactor in accordance with claim 1, wherein an axial length of the stabilization section is 3 to 75 times a flow diameter in the stabilization section.

20. The cavitation reactor in accordance with claim 1, wherein a flow cross-sectional surface in the collapse section widens in a large stage and/or in several small stages, and/or with a constant opening angle and/or with various continuously or non-continuously merging opening angles.

21. The cavitation reactor in accordance with claim 20, wherein the widening of the flow cross-sectional surface in the collapse section is radially symmetrical or helical.

22. (canceled)

23. A method for hydrodynamic generation of substantially homogeneous, oscillating cavitation bubbles in a fluid, comprising the following steps:
accelerating the fluid,
flowing the fluid onto a diaphragm having a plurality of micro-passages, wherein at least 10 micro-passages per cm² are formed over an entire flow cross-sectional surface defined on an oncoming flow side of the diaphragm,
flowing the fluid through the micro-passages to generate the fluid into cavitation bubbles,
stabilizing an oscillation of the cavitation bubbles, and
widening of the flow of the fluid in the direction of the flow in order to collapse the cavitation bubbles.

24. The method in accordance with claim 23, further comprising mixing the fluid with disinfectant before the fluid flows through the micro-passages.

25-27. (canceled)
